(19) United States
(12) Patent Application Publication
(10) Pub. No.: US 2025/0183752 A1
(43) Pub. Date: Jun. 5, 2025

(54) ELECTRIC MACHINE STATOR AND ROTOR W/VIRTUAL NOTCHES

(71) Applicant: FCA US LLC, Auburn Hills, MI (US)

(72) Inventors: Rakesh Khurana, Rochester Hills, MI (US); Reemon Z S Haddad, Rochester Hills, MI (US); Dhafar Al-Ani, Troy, MI (US)

(21) Appl. No.: 18/526,024

(22) Filed: Dec. 1, 2023

(51) Int. Cl. H02K 5/24; H02K 1/16; H02K 1/276; H02K 15/02; H02K 15/03; H02K 21/14

(52) U.S. Cl. CPC H02K 5/24; H02K 1/16; H02K 1/276; H02K 15/021; H02K 15/03; H02K 21/14

(57) ABSTRACT

An electric machine includes a plurality of magnetic stator laminations arranged in a first stacked configuration, a plurality of magnetic rotor laminations arranged in a second stacked configuration, and one or more virtual notches formed in each stator lamination and/or each rotor lamination. Each virtual notch is non-magnetic and configured to function as a physical notch, without removing material from the magnetic stator lamination, to increase mechanical strength in the first and/or second stacked configuration and reduce noise/vibration/harshness (NVH) in the electric machine.

### FIELD

The present application generally relates to electric machines and, more particularly, to an electric machine stator and rotor assembly with improved noise/vibration/harshness (NVH) characteristics.

### BACKGROUND

Electric machines typically include a rotor and stator with windings formed by thin round or rectangular hairpin, individual copper wires. One type of electric machine is an electric traction motor, which can be utilized in electrified vehicles for both propulsion and as generators for energy recapture during braking. However, NVH is one of the main design challenges and design critical parameters for electric machines, particularly in battery electric vehicle (BEV) applications, since internal combustion engine masking sounds are no longer present. Known solutions to mitigate NVH include forming physical cuts or notches on the rotor and stator surfaces, acoustic covers, modified housing ribs, stator winding wax, and acoustic shields. However, such solutions may be complex, costly, and present packaging and weight challenges, as well as potentially create additional mechanical stress that limits the electric machine max operating speed. Accordingly, while such systems do work well for their intended purpose, there exists an opportunity for improvement in the relevant art.

### SUMMARY

According to one example aspect of the invention, an electric machine is provided. In one exemplary implementation, the electric machine includes a plurality of magnetic stator laminations arranged in a first stacked configuration, a plurality of magnetic rotor laminations arranged in a second stacked configuration, and one or more virtual notches formed in each stator lamination and/or each rotor lamination. Each virtual notch is non-magnetic and configured to function as a physical notch, without removing material from the magnetic stator lamination, to increase mechanical strength in the first and/or second stacked configuration and reduce noise/vibration/harshness (NVH) in the electric machine.

In addition to the foregoing, the described stator assembly may include one or more of the following features: wherein each virtual notch is formed by a dual-phase heat treatment process; wherein each stator lamination is generally annular and includes a plurality of stator teeth extending radially inward from a back iron; wherein the one or more virtual notches are formed on the plurality of stator teeth; wherein one virtual notch is formed on each stator tooth; wherein each virtual notch is formed on an inner diameter edge of each stator tooth; wherein each rotor lamination is generally circular and includes an outer diameter, an inner diameter, and a plurality of apertures each configured to receive a permanent magnet; wherein the one or more virtual notches are formed on the outer diameter of each rotor lamination; and wherein each virtual notch is formed proximate one of the apertures.

According to another example aspect of the invention, a method of manufacturing an electric machine is provided. In one implementation, the method includes providing a plurality of stator laminations in a first stacked configuration, providing a plurality of rotor laminations in a second stacked configuration, and forming one or more virtual notches in each stator lamination and/or each rotor lamination. Each virtual notch is non-magnetic and configured to function as a physical notch, without removing material from the magnetic stator lamination, to increase mechanical strength in the first and/or second stacked configuration and reduce noise/vibration/harshness (NVH) in the electric machine.

In addition to the foregoing, the described method may include one or more of the following features: wherein forming the one or more virtual notches comprises performing a dual-phase heat treatment process to the first and/or second stacked configuration; wherein the dual-phase heat treatment process is performed with a laser heater; wherein the dual-phase heat treatment process is performed with an inductive heater; wherein each stator lamination is generally annular and includes a plurality of stator teeth extending radially inward from a back iron; and wherein one virtual notch is formed on each stator tooth.

In addition to the foregoing, the described method may include one or more of the following features: wherein each virtual notch is formed on an inner diameter edge of each stator tooth; wherein each rotor lamination is generally circular and includes an outer diameter, an inner diameter, and a plurality of apertures each configured to receive a permanent magnet; wherein the one or more virtual notches are formed on the outer diameter of each rotor lamination; and wherein each virtual notch is formed proximate one of the apertures.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a cross-sectional view of a portion of an example electric motor for an electric vehicle, in accordance with the principles of the present application;

FIG. 2 is a side view of a portion of an example stator lamination that may be utilized in the electric motor of FIG. 1, in accordance with the principles of the present application;

FIG. 3 is a side view of a portion of an example rotor lamination that may be utilized in the electric motor of FIG. 1, in accordance with the principles of the present application;

FIG. 4 is a side view of a portion of another example rotor lamination that may be utilized in the electric motor of FIG. 1, in accordance with the principles of the present application;

FIG. 5 illustrates various example virtual notch shapes that may be formed in the laminations shown in FIGS. 1-4, in accordance with the principles of the present application;

FIG. 6 illustrates an example method of forming a stator assembly that may be utilized in the electric motor of FIG. 1, in accordance with the principles of the present application; and

FIG. 7 illustrates an example method of forming a rotor assembly that may be utilized in the electric motor of FIG. 1, in accordance with the principles of the present application.

### DESCRIPTION

Described herein are systems and methods for manufacturing electric machines, such as electric traction motors, with an improved stator and rotor assembly design to improve overall performance and reduce or eliminate NVH. The stator and rotor are assembled from a plurality of steel laminations each formed with a plurality of virtual notches to improve NVH, losses, and mechanical strength. The virtual notches are formed with a dual-phase process implemented by applying a local heat treatment, for example, via an inductive heater, ultrasonic heating, or laser heater. The process is configured to change the material properties of the heat-treated region from a magnetic region to a non-magnetic region with higher yield strength properties. As such, the laminations have non-magnetic phase regions (the virtual notches) with the remainder region of the lamination having a magnetic phase.

As a result, the formed non-magnetic regions facilitate improved NVH performance by reducing the radial and tangential electromagnetic forces generated from the electromagnetic design of the electric machine. These forces are the main contributor to the overall electric machine and NVH (e.g., in terms of sound pressure and sound power). In addition, the heat treatment process is configured to increase the electric steel yield strength to improve the rotor/stator mechanical strength under high-speed operation. Moreover, the process allows placement of the virtual notches as close as possible to permanent magnets to maximize NVH improvement.

As such, the described systems include applying the dual-phase concept to the rotor and/or stator to create virtual notches. The heat treatment process may be applied on the full rotor and stator stack and/or assembly or it can be applied on a lamination-by-lamination basis. Advantageously, the virtual notches may be symmetrical or unsymmetrical around the rotor/stator and may have varying shapes throughout depending on the desired/targeted harmonics orders for the particular design. The heat-treated regions increase electric machine stiffness, which provides additional mechanical stability. In addition, the virtual notches reduce the generated radial and tangential forces, resulting in minimized overall NVH orders.

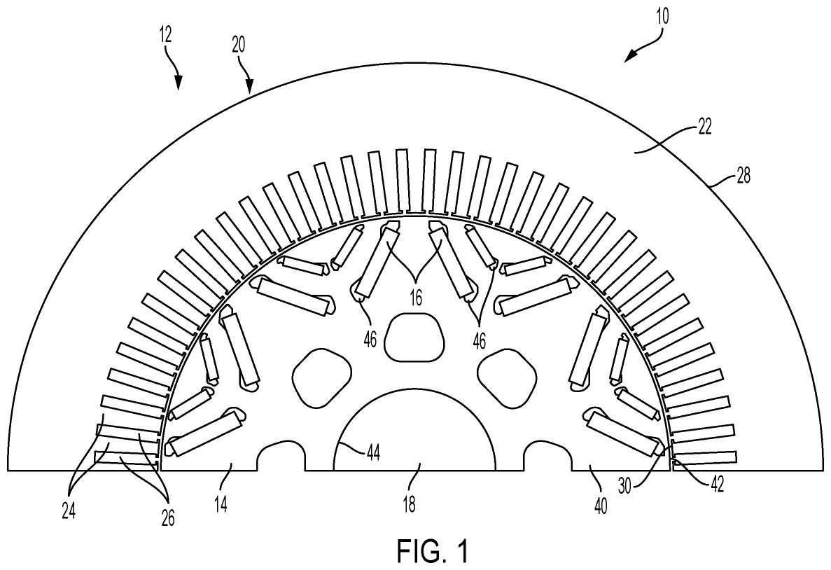

Referring now to FIG. 1, a portion of an example electric machine is illustrated and generally identified at reference numeral 10. In the example embodiments, the electric machine 10 is described as an electric traction motor for an electric vehicle, but it will be appreciated that the features described herein may be applied to various electric machines. For example, electric machine 10 may be an interior permanent magnet machine, a surface mounted permanent magnet machine, an induction machine, a switch reluctance machine, a permanent magnet assisted synchronous reluctance machine, a wound rotor synchronous machine, an axial flux machine, or an externally excited synchronous machine.

In the illustrated example, the electric traction motor 10 generally includes a stator assembly 12 operably associated with a rotor assembly 14 having a plurality of permanent magnets 16. In general, the stator assembly 12 receives electrical power to produce a magnetic field, which interacts with a magnetic field of the rotor assembly 14 to produce mechanical power to a shaft 18.

In the example embodiment, the stator assembly 12 is formed from a plurality of individual annular stator laminations 20 (only one shown). The stator laminations 20 are stacked one on top of the other to a length known as the stack length, which determines the torque and power output of the electric machine 10. The stator laminations 20 are coupled together, for example, by gluing, interlocking, welding, or other suitable joining technique. The number of stator laminations 20 of the stack length can be based on design considerations and, as such, stator assembly 12 may have any suitable number of stator laminations 20.

In the illustrated example, each stator lamination 20 is fabricated from a magnetic steel in a punching die, laser cut, 3D printing, etc. (not shown) to produce a generally annular component (only half shown) having a back iron 22 with a plurality radially aligned teeth 24 extending radially inward from the back iron 22. The stator teeth 24 define slots 26 therebetween through which coil windings (not shown) are wound. The back iron defines an outer diameter 28 and the distal end of each stator tooth 24 defines an inner diameter edge 30.

In the example embodiment, the rotor assembly 14 is formed from a plurality of individual circular rotor laminations 40 (only one shown). The rotor laminations 40 are stacked one on top of the other to a stack length, which further determines the torque and power output of the electric machine 10. The rotor laminations 40 are coupled together, for example, by gluing, interlocking, welding, or other suitable joining technique. The number of rotor laminations 40 of the stack length can be based on design considerations and, as such, rotor assembly 14 may have any suitable number of rotor laminations 40.

In the illustrated example, each rotor lamination 40 is fabricated from a magnetic steel in a punching die, laser cut, 3D printing, etc. (not shown) to produce a generally circular component (only half shown) having an outer diameter 42, an inner diameter 44, and a plurality of slots or apertures 46 for receiving one or more of the permanent magnets 16. The outer diameter 42 faces the stator inner diameter edge 30, and the inner diameter 44 receives and is mechanically coupled (e.g., splined) to the shaft 18. During assembly, the rotor laminations 40 are stacked such that the apertures 46 are aligned to receive the permanent magnets 16 through the stacked configuration.

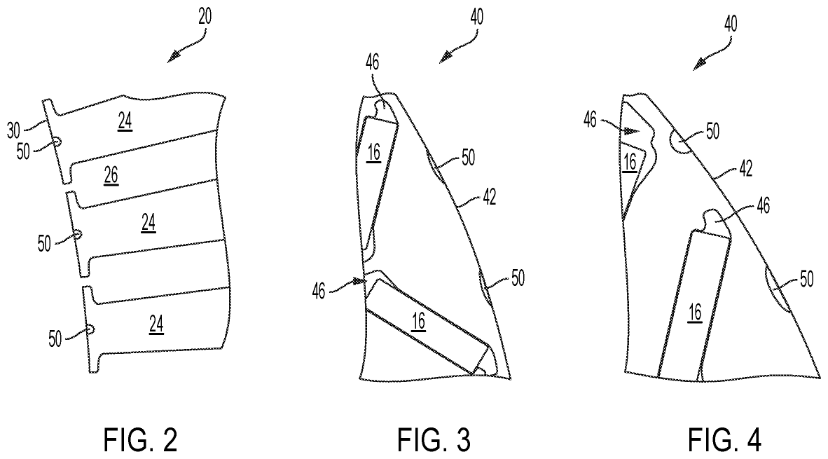

With additional reference to FIGS. 2-4, various portions of the stator/rotor laminations 20, 40 are subjected to a dual phase heat treatment process to create virtual notches 50 (e.g., non-magnetic regions) on the rotor and/or stator surfaces to change the magnetic properties of the electric steel in these regions from magnetic to non-magnetic properties. In one example, a non-magnetic property or phase is where 90% or approximately 90% of the material of the region is non-magnetic. These virtual notches 50 have the same function as physical notches to improve NVH. However, since the virtual notch is not a physical notch (i.e., no lamination material is removed), the mechanical strength of the stator/rotor assembly 12, 14 is maintained, which obviates any mechanical strength restrictions and enables the electric machine 10 to operate at higher speeds and improves overall efficiency thereof.

Example locations of virtual notches 50 include at the inner diameter edge 30 of one or more stator teeth 24, as shown in FIG. 2, and at the rotor lamination outer diameter 42 proximate permanent magnet 16, as shown in FIGS. 3 and 4. However, it will be appreciated that virtual notches 50 may be formed in any suitable number and location on the stator lamination 20 and rotor lamination 40 to improve NVH and mechanical strength. It will also be appreciated that various patterns and configurations are envisioned based on various design factors such as strength and NVH requirements.

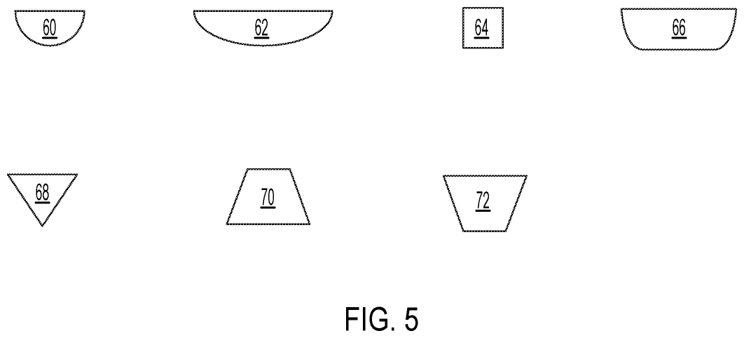

With reference now to FIG. 5, various example shapes of virtual notches 50 are illustrated. The example shapes include a semi-circular shape 60, a semi-elliptical shape 62, a rectangular/square shape 64, a rounded rectangular shape 66, a triangular shape 68, and a trapezoidal shape 70, 72. In one example, the upper edge of the shape (as shown in FIG. 5) is configured to be positioned along an edge of the stator/rotor lamination 20, 40. In some implementations, not shown, the virtual notch 50 may be a continuous shape formed on the rotor surface to form a sine or cosine airgap shape. However, it will be appreciated that virtual notches 50 are not limited to the described shapes and could have various other shapes. Moreover, it will also be appreciated that each stator/rotor lamination may have various combinations of shapes, for example as shown in FIG. 4.

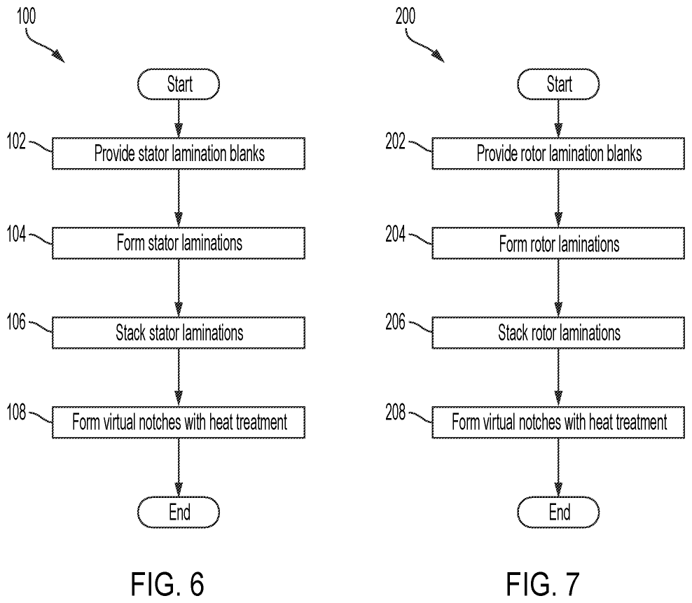

FIG. 6 illustrates an example method 100 of manufacturing stator assembly 12. The method begins at step 102 where a plurality of stator lamination blanks is provided. At step 104, each stator lamination blank is processed and formed with stator teeth 24 to produce a plurality of stator laminations 20. In the example embodiment, the stator laminations 20 are formed in a die press operation. At step 106, the stator laminations 20 are stacked and coupled with stator teeth 24 aligned to form a stacked configuration. At step 108, one or more heat treatment processes are performed on the lamination stack to form one or more virtual notches 50 in a desired location such as, for example, in a central location of each stator tooth 24 along inner diameter edge 30. As previously described, the heat treatment process changes the property of the virtual notch from magnetic to non-magnetic.

FIG. 7 illustrates an example method 200 of manufacturing rotor assembly 14. The method begins at step 202 where a plurality of rotor lamination blanks is provided. At step 204, each rotor lamination blank is processed and formed with outer diameter 42, inner diameter 44, and aperture(s) 46 to produce a plurality of rotor laminations 40. In the example embodiment, the rotor laminations 40 are formed in a die press operation. At step 206, the rotor laminations 40 are stacked and coupled with apertures 46 aligned to form a stacked configuration. At step 208, one or more heat treatment processes are performed on the lamination stack to form one or more virtual notches 50 in a desired location such as, for example, along outer diameter 42 proximate apertures 46, which subsequently receive permanent magnets 16. As previously described, the heat treatment process changes the property of the virtual notch from magnetic to non-magnetic.

Described herein are systems and methods for manufacturing electric machines, such as electric traction motors, with an improved stator and/or rotor assembly design to improve mechanical strength and reduce or eliminate NVH. The stator and rotor are each assembled from a plurality of magnetic steel laminations. A dual-phase heat treatment is applied to desired locations on each lamination or stack of laminations to form a virtual notch with a non-magnetic property, without removing material from the lamination(s). This advantageously does not require additional mass or thermal limitation for the stack, reduces manufacturing complexity, and does not have packaging restraints or require extra space. As such, NVH performance, mechanical design, thermal performance, and overall efficiency are improved for the electric machine and associated electric drive module (EDM). The number, shape, and location of virtual notches can be varied based on a number of factors.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. An electric machine, comprising:
a plurality of magnetic stator laminations arranged in a first stacked configuration;
a plurality of magnetic rotor laminations arranged in a second stacked configuration; and
one or more virtual notches formed in each stator lamination and/or each rotor lamination,
wherein each virtual notch is non-magnetic and configured to function as a physical notch, without removing material from the magnetic stator lamination, to increase mechanical strength in the first and/or second stacked configuration and reduce noise/vibration/harshness (NVH) in the electric machine.

2. The electric machine of claim 1, wherein each virtual notch is formed by a dual-phase heat treatment process.

3. The electric machine of claim 1, wherein each stator lamination is generally annular and includes a plurality of stator teeth extending radially inward from a back iron.

4. The electric machine of claim 3, wherein the one or more virtual notches are formed on the plurality of stator teeth.

5. The electric machine of claim 3, wherein one virtual notch is formed on each stator tooth.

6. The electric machine of claim 5, wherein each virtual notch is formed on an inner diameter edge of each stator tooth.

7. The electric machine of claim 1, wherein each rotor lamination is generally circular and includes an outer diameter, an inner diameter, and a plurality of apertures each configured to receive a permanent magnet.

8. The electric machine of claim 7, wherein the one or more virtual notches are formed on the outer diameter of each rotor lamination.

9. The electric machine of claim 8, wherein each virtual notch is formed proximate one of the apertures.

10. A method of manufacturing an electric machine, the method comprising:
providing a plurality of stator laminations in a first stacked configuration;
providing a plurality of rotor laminations in a second stacked configuration; and
forming one or more virtual notches in each stator lamination and/or each rotor lamination,
wherein each virtual notch is non-magnetic and configured to function as a physical notch, without removing material from the magnetic stator lamination, to increase mechanical strength in the first and/or second stacked configuration and reduce noise/vibration/harshness (NVH) in the electric machine.

11. The method of claim 10, wherein forming the one or more virtual notches comprises performing a dual-phase heat treatment process to the first and/or second stacked configuration.

12. The method of claim 11, wherein the dual-phase heat treatment process is performed with a laser heater.

13. The method of claim 11, wherein the dual-phase heat treatment process is performed with an inductive heater.

14. The method of claim 10, wherein each stator lamination is generally annular and includes a plurality of stator teeth extending radially inward from a back iron.

15. The method of claim 14, wherein one virtual notch is formed on each stator tooth.

16. The method of claim 15, wherein each virtual notch is formed on an inner diameter edge of each stator tooth.

17. The method of claim 10, wherein each rotor lamination is generally circular and includes an outer diameter, an inner diameter, and a plurality of apertures each configured to receive a permanent magnet.

18. The method of claim 17, wherein the one or more virtual notches are formed on the outer diameter of each rotor lamination.

19. The method of claim 18, wherein each virtual notch is formed proximate one of the apertures.
